(19) United States
(12) Patent Application Publication
(10) Pub. No.: US 2026/0229778 A1
(43) Pub. Date: Aug. 6, 2026

(54) ELECTRONIC DEVICE

(71) Applicant: HUAWEI TECHNOLOGIES CO., LTD., Shenzhen,Guangdong (CN)

(72) Inventors: Huatao Liu, Shanghai (CN); Dong Yu, Shanghai (CN); Jikang Wang, Shanghai (CN)

(73) Assignee: HUAWEI TECHNOLOGIES CO., LTD., Shenzhen,Guangdong (CN)

(21) Appl. No.: 19/149,828

(22) PCT Filed: Jan. 4, 2024
(86) PCT No.: PCT/CN2024/070643

§ 371 Date: Jul. 21, 2025

(30) Foreign Application Priority Data
Jan. 20, 2023 (CN) 202310101339.X

(51) Int. Cl. H01Q 5/342; H01Q 1/24; H01Q 13/10; H01Q 21/28

(52) U.S. Cl. CPC H01Q 5/342; H01Q 1/243; H01Q 13/10; H01Q 21/28

(57) ABSTRACT

An electronic device includes a first conductive side frame, an antenna and a first feed element. The first conductive side frame comprises a first side frame between a first position and a second position, and a second side frame between the second position and a third position. The second position is provided with a first slot. The antenna comprises a radiator having the first side frame grounded at the first position, and the second side frame grounded at the third position. The first side frame comprises a first feed point, and an operating frequency band of the antenna comprises a first frequency band and a second frequency band higher than the first frequency band. The first feed element comprises a first radio frequency channel corresponding to the first frequency band, and a second radio frequency channel corresponding to the second frequency band, that are coupled to the first side frame.

This application claims priority to Chinese Patent Application No. 202310101339.X, filed with the China National Intellectual Property Administration on Jan. 20, 2023 and entitled “ELECTRONIC DEVICE”, which is incorporated herein by reference in its entirety.

### TECHNICAL FIELD

This application relates to the field of wireless communication, and in particular, to an electronic device.

### BACKGROUND

In a satellite navigation or communication system, compared with a linearly polarized antenna, a circularly polarized antenna has some unique advantages. For example, polarization rotation (polarization rotation) (generally referred to as “Faraday rotation (Faraday rotation)”) occurs when a linearly polarized wave passes through an ionosphere, but a circularly polarized wave can resist the Faraday rotation due to rotation symmetry. Therefore, the circularly polarized antenna is usually used as a transmit or receive antenna in satellite navigation or communication. In addition, in the satellite navigation or communication system, if a conventional linearly polarized antenna is used to receive a circularly polarized wave from a satellite, half of energy is lost due to polarization mismatch.

However, in consideration of factors such as an industrial design (industrial design, ID) and an overall structure of an electronic device, currently, the linearly polarized antenna is adopted for designing an antenna of an existing terminal electronic device, and a circular polarization characteristic of the antenna is not studied. However, an external antenna is usually used to realize circular polarization for an existing dedicated satellite terminal, and the antenna is mostly in a form of large-sized four-wall spiral antenna, which cannot implement built-in integration of the antenna. Therefore, it is of great significance to design a built-in circularly polarized antenna or a circularly polarized antenna that is conformal to an appearance for implementing functions such as satellite communication or navigation in the terminal electronic device.

### SUMMARY

Embodiments of this application provide an electronic device, including an antenna. The antenna uses a partial side frame on two adjacent sides of a side frame as a radiator, and the antenna is separately in left-hand circular polarization and right-hand circular polarization on a first frequency band and a second frequency band by using a single feed point. In addition, because left-hand circular polarization and right-hand circular polarization are generated based on a same feed point and a same slot provided on the radiator, a difference between a maximum radiation direction of a pattern generated on the first frequency band and a maximum radiation direction of a pattern generated on the second frequency band is small, and an overlapping part between the pattern generated on the first frequency band and the pattern generated on the second frequency band increases, to meet a requirement for angle alignment of the antenna on the first frequency band and the second frequency band.

According to a first aspect, an electronic device is provided, including: a first conductive side frame, where the first conductive side frame includes a first side and a second side that intersect at an angle, the first side includes a first position and a second position, the second side includes a third position, the second position is located between the first position and the third position, the second position is provided with a first slot, a side frame between the first position and the second position is a first side frame, and a side frame between the second position and the third position is a second side frame; an antenna, where the antenna includes a radiator, the radiator includes the first side frame and the second side frame, the first side frame is grounded at the first position, the second side frame is grounded at the third position, the first side frame includes a first feed point, an operating frequency band of the antenna includes a first frequency band and a second frequency band, and a frequency of the first frequency band is lower than a frequency of the second frequency band; and a first feed element, where the first feed element includes a first radio frequency channel and a second radio frequency channel, the first radio frequency channel is coupled to the first side frame at the first feed point, the second radio frequency channel is coupled to the first side frame at the first feed point, an operating frequency band of the first radio frequency channel includes the first frequency band, and an operating frequency band of the second radio frequency channel includes the second frequency band.

According to the technical solution in this embodiment of this application, when a radio frequency signal is fed at the first feed point, the radiator may simultaneously excite a longitudinal mode and a transverse mode in the foregoing embodiment on the first frequency band and the second frequency band, so that a polarization manner of the first antenna is circular polarization.

In addition, because an open end (an ungrounded end) of the first side frame is located on a first side (for example, a left side) of the first slot, and an open end of the second side frame is located on a second side (for example, a right side) of the first slot. Therefore, a circular polarization rotation direction of the first frequency band mainly excited by the first side frame is reverse to a circular polarization rotation direction of the second frequency band mainly excited by the second side frame, so that the first antenna can be used in a satellite communication system (in the satellite communication system, a circular polarization rotation direction of a transmit frequency band is reverse to a circular polarization rotation direction of a receive frequency band).

In addition, because both resonance generated on the first frequency band and resonance generated on the second frequency band are generated when a radio frequency signal is fed at a same feed point, and the resonance generated on the first frequency band and the resonance generated on the second frequency band share the first slot provided at the second position, a difference between a maximum radiation direction of a pattern generated on the first frequency band and a maximum radiation direction of a pattern generated on the second frequency band is small, so that an overlapping part between the pattern generated on the first frequency band and the pattern generated on the second frequency band increases, to meet a requirement for angle alignment of the first antenna on the first frequency band and the second frequency band. The overlapping part between the pattern generated on the first frequency band and the pattern generated on the second frequency band can enable the electronic device to have good satellite communication performance.

With reference to the first aspect, in some implementations of the first aspect, the electronic device further includes a first switch, a common port of the first switch is coupled to the first side frame at the first feed point, a first port of the first switch is electrically connected to the first radio frequency channel, and a second port of the first switch is electrically connected to the second radio frequency channel.

According to the technical solution in this embodiment of this application, the first switch may be configured to switch an electrical connection state between the first feed point and each of first radio frequency channel and the second radio frequency channel, so that a radio frequency signal is fed through the first radio frequency channel and the second radio frequency channel at the first feed point in different timeslots, to implement time division duplex (time division dual TDD) of a feed circuit.

With reference to the first aspect, in some implementations of the first aspect, the first side may include a fourth position, the first position is located between the second position and the fourth position, the fourth position is provided with a second slot, and a side frame between the first position and the fourth position is a third side frame; the side frame further includes a third side that intersects the first side at an angle, the third side or the first side includes a fifth position, and a side frame between the fourth position and the fifth position is a fourth side frame; and the radiator includes the third side frame and the fourth side frame.

With reference to the first aspect, in some implementations of the first aspect, the first slot and the second slot are symmetric along a virtual axis of the first side.

According to the technical solution in this embodiment of this application, as symmetry of a structure of the first antenna increases, radiation performance of the first antenna increases accordingly.

With reference to the first aspect, in some implementations of the first aspect, the fourth side frame includes a connection point, and the fourth side frame is grounded at the fifth position and the connection point.

According to the technical solution in this embodiment of this application, the connection point may be configured to adjust current distribution on a ground plane when the first antenna operates on the first frequency band, so that the maximum radiation direction of the pattern generated on the first frequency band is close to the maximum radiation direction of the pattern generated on the second frequency band, and the difference between the maximum radiation direction of the pattern generated on the first frequency band and the maximum radiation direction of the pattern generated by the second frequency band is reduced. This increases an overlapping degree between the pattern generated on the first frequency band and the pattern generated on the second frequency band, and improves accuracy of transmitting a BeiDou communication short message by the first antenna.

With reference to the first aspect, in some implementations of the first aspect, a distance between the connection point and the fourth position is less than a distance between the connection point and the fifth position.

According to the technical solution in this embodiment of this application, the distance between the connection point and the fourth position is less than the distance between the connection point and the fifth position, so that the maximum radiation direction of the pattern generated on the first frequency band is closer to the maximum radiation direction of the pattern generated on the second frequency band.

With reference to the first aspect, in some implementations of the first aspect, the first feed element further includes a third radio frequency channel, and the first radio frequency channel is electrically connected to a third port of the first switch; the electronic device further includes a second feed element, a third feed element, and a fourth feed element; the second side frame includes a second feed point, and the second feed element is coupled to the second side frame at the second feed point; the third side frame includes a third feed point, and the third feed element is coupled to the third side frame at the third feed point; and the fourth feed element is coupled to the fourth side frame at the connection point.

According to the technical solution in this embodiment of this application, the first side frame and the third radio frequency channel in the first feed element may form a second antenna (when the first antenna does not operate, the common port of the first switch is conducted with the third port, and a radio frequency signal is fed through the third radio frequency channel). In an embodiment, an operating frequency band of the second antenna may include at least some low frequency bands of a cellular network.

The second side frame and the second feed element may form a third antenna. In an embodiment, an operating frequency band of the third antenna may include at least some medium-high frequency bands of a cellular network.

The third side frame and the third feed element may form a fourth antenna. In an embodiment, an operating frequency band of the fourth antenna may include at least a part of a 5G frequency band and a sub-6G frequency band (for example, a frequency band N77, N78, or N79) of Wi-Fi.

The fourth side frame and the fourth feed element may form a fifth antenna. In an embodiment, an operating frequency band of the fifth antenna may include at least an L5 frequency band of GPS and a 2.4G frequency band of Wi-Fi.

Because a spatial layout in the electronic device is compact, the first antenna 210 may reuse a radiator with an antenna on another frequency band, so that antenna layouts on more communication frequency bands are implemented in same space.

With reference to the first aspect, in some implementations of the first aspect, the electronic device further includes a second switch, a common port of the second switch is coupled to the second side frame at the second feed point, a first port of the second switch is grounded, and a second port of the second switch is electrically connected to the second feed element.

With reference to the first aspect, in some implementations of the first aspect, the electronic device further includes a third switch, a common port of the third switch is coupled to the fourth side frame at the connection point, and a first port of the third switch is grounded.

According to the technical solution in this embodiment of this application, because the first antenna reuses a radiator with the second antenna, the third antenna, the fourth antenna, and the fifth antenna, when the first antenna operates, none of the second antenna, the third antenna, the fourth antenna, and the fifth antenna operates.

Correspondingly, the common port of the first switch is conducted with the first port (the first radio frequency channel) and the second port (the second radio frequency channel) in different timeslots, so that the radio frequency signals of the first frequency band and the second frequency band are fed at the first feed point.

The common port of the second switch is conducted with the first port, so that the second side frame is grounded at the second feed point. Because on a satellite communication frequency band, power of a radio frequency signal fed at the first feed point is large, the second switch may be configured to avoid a case in which an electronic element between the second feed point and the second feed element is damaged as a radio frequency signal coupled to the second side frame flows into the second feed element.

The common port of the third switch is conducted with the first port, so that the fourth side frame is grounded at the connection point. The fourth side frame may be grounded at the connection point, so that the maximum radiation direction of the pattern generated on the first frequency band is close to the maximum radiation direction of the pattern generated on the second frequency band.

With reference to the first aspect, in some implementations of the first aspect, the electronic device further includes a first matching network, where the first matching network includes a fourth switch and a plurality of first electronic elements, the first electronic element is electrically connected between the first feed point and the fourth switch, and a common port of the fourth switch is grounded.

With reference to the first aspect, in some implementations of the first aspect, the electronic device further includes a second matching network, where the second matching network includes a fifth switch and a plurality of second electronic elements, the second electronic element is electrically connected between the first port of the second switch and the fifth switch, and a common port of the fifth switch is grounded.

With reference to the first aspect, in some implementations of the first aspect, the electronic device further includes a third matching network, where the third matching network includes a sixth switch and a plurality of third electronic elements, the third electronic element is electrically connected between the second port of the second switch and the sixth switch, and a common port of the sixth switch is grounded.

With reference to the first aspect, in some implementations of the first aspect, the electronic device further includes a hinge, a first housing, and a second housing, where the hinge is located between the first housing and the second housing, the hinge is rotatably connected to the first housing and the second housing separately, the first housing includes the first conductive side frame, and the second housing includes a second conductive side frame.

According to the technical solution in this embodiment of this application, the electronic device is a foldable electronic device. In a folded state, a parasitic stub disposed on the second conductive side frame may be used to improve efficiency of an antenna disposed on the first conductive side frame. In addition, the parasitic stub may be used to guide the maximum radiation direction of the pattern generated on the first frequency band or the maximum radiation direction of the pattern generated on the second frequency band, so that an overlapping part between the pattern generated on the first frequency band and the pattern generated on the second frequency band can improve satellite communication performance of the electronic device.

With reference to the first aspect, in some implementations of the first aspect, a distance between the first feed point and the second position is less than one third of a distance between the first position and the second position.

With reference to the first aspect, in some implementations of the first aspect, a circular polarization axial ratio of the antenna on the first frequency band is less than or equal to 10 dB; and/or a circular polarization axial ratio of the antenna on the second frequency band is less than or equal to 10 dB.

According to the technical solution in this embodiment of this application, when the circular polarization axial ratio of the antenna is less than or equal to 10 dB, it may be considered that the antenna has a good circular polarization characteristic.

With reference to the first aspect, in some implementations of the first aspect, a distance L3 between the first position and the third position and a length L4 of the first side satisfy the following: 7×L4/16≤L3≤9×L4/16.

With reference to the first aspect, in some implementations of the first aspect, the first frequency band includes 1610 MHz to 1626.5 MHz, and/or the second frequency band includes 2483.5 MHz to 2500 MHz.

With reference to the first aspect, in some implementations of the first aspect, a polarization manner of the antenna on the first frequency band is left-hand circular polarization; and/or a polarization manner of the antenna on the second frequency band is right-hand circular polarization.

According to the technical solution in this embodiment of this application, the first frequency band may include a transmit frequency band (1610 MHz to 1626.5 MHz) of a BeiDou satellite system communication technology. In an embodiment, the second frequency band may include a receive frequency band (2483.5 MHz to 2500 MHz) of the BeiDou satellite system communication technology.

### BRIEF DESCRIPTION OF DRAWINGS

FIG. 1 is a diagram of an electronic device according to an embodiment of this application;

FIG. 2 is a diagram of a usage scenario of a circularly polarized antenna according to an embodiment of this application;

FIG. 3 is a diagram of a circularly polarized antenna according to an embodiment of this application;

FIG. 4 is a diagram of a structure of an electronic device 100 according to an embodiment of this application;

FIG. 5(a) to FIG. 5(d) are a diagram of energy flow distribution in a transverse mode and a longitudinal mode according to an embodiment of this application;

FIG. 6 is a diagram of a structure of an electronic device 200 according to an embodiment of this application;

FIG. 7 is a diagram of a structure of an electronic device 200 according to an embodiment of this application;

FIG. 8 is a diagram of a structure of an electronic device 200 according to an embodiment of this application;

FIG. 9 is a diagram of a structure of a first matching network 271 according to an embodiment of this application;

FIG. 10 is a diagram of structures of a second matching network 272 and a third matching network 273 according to an embodiment of this application;

FIG. 11 is a diagram of a simulation result of an S parameter of a first antenna 210 shown in FIG. 8;

FIG. 12 is a diagram of current distribution of a first antenna 210 shown in FIG. 8 on a first frequency band (1.62 GHz);

FIG. 13 is a diagram of current distribution of a first antenna 210 shown in FIG. 8 on a second frequency band (2.5 GHZ);

FIG. 14 is an axial ratio pattern of a first antenna 210 shown in FIG. 8 on a first frequency band (1.62 GHz);

FIG. 15 is an axial ratio pattern of a first antenna 210 shown in FIG. 8 on a second frequency band (2.5 GHZ);

FIG. 16(a) to FIG. 16(c) show gain simulation results of a first antenna 210 shown in FIG. 8 on a first frequency band (1.62 GHZ) and a second frequency band (2.5 GHZ);

FIG. 17 (a) and FIG. 17 (b) are a diagram of a graphical user interface according to an embodiment of this application;

FIG. 18 is a diagram of another electronic device 200 according to an embodiment of this application;

FIG. 19 is a diagram of an electronic device 200 in a folded state according to an embodiment of this application;

FIG. 20(a) and FIG. 20(b) show gain simulation results of a first antenna on a first frequency band (1.62 GHZ) and a second frequency band (2.5 GHZ) when the electronic device shown in FIG. 18 is in an unfolded state; and

FIG. 21(a) and FIG. 21(b) show gain simulation results of a first antenna on a first frequency band (1.62 GHz) and a second frequency band (2.5 GHZ) when the electronic device shown in FIG. 18 is in a folded state.

### DESCRIPTION OF EMBODIMENTS

The following explains terms that may appear in embodiments of this application.

Coupling: The coupling may be understood as direct coupling and/or indirect coupling, and a “coupling connection” may be understood as a direct coupling connection and/or an indirect coupling connection. The direct coupling may also be referred to as an “electrical connection”, which may be understood as physical contact and electrical conduction of components, or may be understood as a form of connection between different components in a line structure through a physical line that can transmit an electrical signal, like a printed circuit board (printed circuit board, PCB) copper foil or a conducting wire. The “indirect coupling” may be understood as electrical conduction of two conductors in a spaced/non-contact manner. In an embodiment, the indirect coupling may also be referred to as capacitive coupling. For example, signal transmission is implemented by forming an equivalent capacitor through coupling in a slot between two spaced conductive members.

Connection/being connected to: The connection/being connected to may mean a mechanical connection relationship or a physical connection relationship, for example, a connection between A and B or that A is connected to B may mean that there is a fastening component (like a screw, a bolt, or a rivet) between A and B, or A and B are in contact with each other and A and B are difficult to be separated.

Connection: That two or more components are conducted or connected in the “electrical connection” or “indirect coupling” manner to perform signal/energy transmission may be referred to as connection.

Opposite/being disposed opposite to each other: That A is disposed opposite to B may mean that A and B are disposed opposite to each other or face to face (opposite to, or face to face).

Lumped element/component: The lumped element/component is a general name of all elements whose sizes are far less than a wavelength corresponding to an operating frequency of a circuit. For a signal, a characteristic of the element is always kept fixed at any time, regardless of a frequency.

Distributed element/component: A difference between the distributed element/component and the lumped element lies in that if a size of an element is close to or greater than a wavelength corresponding to an operating frequency of a circuit, a characteristic of each point of the element varies with a signal when the signal passes through the element. In this case, the element cannot be considered as a single body with a fixed characteristic, but should be referred to as a distributed element.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor formed by using two conductive members that are spaced by a specific slot.

Inductor: The inductor may be understood as a lumped inductor and/or a distributed inductor. The lumped inductor is an inductive component, for example, an inductive element. The distributed inductor (or a distributed type inductor) is an equivalent inductor formed by using a conductive member of a specific length.

Radiator: The radiator is an apparatus configured to receive/send electromagnetic wave radiation in an antenna. In some cases, in a narrow sense, the “antenna” is the radiator. The radiator converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator through a feed line. The radiator converts the energy into specific polarized electromagnetic wave energy and transmits the energy in a required direction. A receive radiator converts specific polarized electromagnetic wave energy from a specific direction of space into modulated high-frequency current energy, and transmits the modulated high-frequency current energy to an input end of a receiver through a feed line.

The radiator may include a conductor having a specific shape and size, for example, a linear radiator or a sheet-like radiator. A specific shape is not limited in this application. In an embodiment, a linear radiator may be referred to as a wire antenna for short. In an embodiment, the linear radiator may be implemented by a conductive side frame, and may alternatively be referred to as a side frame antenna. In an embodiment, the linear radiator may be implemented by a support conductor, and may also be referred to as a support antenna. In an embodiment, a wire diameter (for example, including a thickness and a width) of the linear radiator or a radiator of the wire antenna is much less than a wavelength (for example, a dielectric wavelength) (for example, is less than 1/16 of the wavelength), and a length may be compared to the wavelength (for example, the dielectric wavelength) (for example, the length is near ⅛ of the wavelength, or ⅛ to ¼ of the wavelength, or ¼ to ½ of the wavelength, or greater). Main forms of the wire antenna include the following: a dipole antenna, a half-wave dipole antenna, a monopole antenna, a loop antenna, an inverted F antenna (inverted F antenna, IFA), and a planar inverted F antenna (planar inverted F antenna, PIFA). For example, for the dipole antenna, each dipole antenna usually includes two radiation stubs, and each stub is fed by a feed part from a feed end of the radiation stub. For example, the inverted F antenna (inverted F antenna, IFA) may be considered as being obtained by adding a ground path to a monopole antenna. The IFA antenna has a feed point and a ground point. A side view of the IFA antenna is inverted F-shaped, and therefore, the IFA antenna is referred to an inverted F antenna. In an embodiment, the sheet-like radiator may include a microstrip antenna or a patch (patch) antenna. In an embodiment, the sheet-like radiator may be implemented by a planar conductor (for example, a conductive sheet or a conductive coating). In an embodiment, the sheet-like radiator may include a conductive sheet, for example, a copper sheet. In an embodiment, the sheet-like radiator may include a conductive coating, for example, silver paste. A shape of the sheet-like radiator includes a circle, a rectangle, a ring, and the like. A specific shape is not limited in this application. A structure of the microstrip antenna generally includes a dielectric substrate, a radiator, and a ground plane. The dielectric substrate is disposed between the radiator and the ground plane.

The radiator may also include a slot or a slit formed on a conductor, for example, a closed or semi-closed slot or slit formed on a grounded conductor surface. In an embodiment, a radiator with a slot or slit may be referred to as a slot antenna or a slotted antenna for short. In an embodiment, a radiator with a closed slot or slit may be referred to as a closed slot antenna for short. In an embodiment, a radiator with a semi-closed slot or slit (for example, an opening is additionally provided on the closed slot or slit) may be referred to as an open slot antenna for short. In some embodiments, a shape of the slot is a long strip. In some embodiments, a length of the slot is approximately half a wavelength (for example, the dielectric wavelength). In some embodiments, a length of the slot is approximately an integer multiple of the wavelength (for example, a one-time dielectric wavelength). In some embodiments, the slot may be used for feeding by using a transmission line bridged on one side or two sides of the slot. In this way, a radio frequency electromagnetic field is excited on the slot, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced from the ground plane and is grounded at two ends of the radiator, to form a closed or semi-closed slot or slit. In an embodiment, the radiator of the slot antenna or the slotted antenna may be implemented by a support conductor that is grounded at both ends, and may also be referred to as a support antenna.

Resonance/resonance frequency: The resonance frequency is also called a resonant frequency. The resonance frequency may be a frequency at which an imaginary part of an input impedance of an antenna is zero. The resonance frequency may have a frequency range, namely, a frequency range in which resonance occurs. A frequency corresponding to a strongest resonance point is a center frequency. A return loss of the center frequency may be less than −20 dB.

Resonance frequency band: A range of a resonance frequency is the resonance frequency band, and a return loss of any frequency on the resonance frequency band may be less than −6 dB or −5 dB.

Communication frequency band/operating frequency band: Regardless of a type of antenna, the antenna always operates in a specific frequency range (a frequency band width). For example, an operating frequency band of an antenna supporting a B40 frequency band includes a frequency in a range of 2300 MHz to 2400 MHz. In other words, an operating frequency band of the antenna includes a B40 frequency band. A frequency range that satisfies a requirement of an indicator may be considered as an operating frequency band of the antenna.

The resonance frequency band and the operating frequency band may be the same or different, or frequency ranges thereof may partially overlap. In an embodiment, the resonance frequency band of the antenna may cover a plurality of operating frequency bands of the antenna.

Electrical length: The electrical length may be a ratio of a physical length (namely, a mechanical length or a geometric length) to a wavelength of a transmitted electromagnetic wave, and the electrical length may satisfy the following formula:

$$\overline{L} = \frac{L}{λ} ,$$

where

L is the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz, the operating wavelength may be a wavelength calculated by using the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in the air may be calculated as follows: (Air wavelength or vacuum wavelength)=Speed of light/Frequency, where the frequency is a frequency (MHz) of the radiation signal, and the speed of light may be 3×108 m/s. A wavelength of a radiated signal in a medium may be calculated as follows: Dielectric wavelength-(Speed of light/VE)/Frequency, where E is a relative dielectric constant of the medium. The wavelength in embodiments of this application is usually a dielectric wavelength, and may be a dielectric wavelength corresponding to the center frequency of the resonance frequency, or a dielectric wavelength corresponding to the center frequency of the operating frequency band supported by the antenna. For example, it is assumed that a center frequency of a B1 uplink frequency band (with a resonance frequency ranging from 1920 MHz to 1980 MHz) is 1955 MHz, the wavelength may be a dielectric wavelength calculated by using the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in embodiments of this application may be simply calculated by using a relative dielectric constant of a medium filled in one or more sides of a radiator.

Limitations related to a position and a distance, such as being in the middle or at a middle position, mentioned in embodiments of this application are all described in terms of a current process level, and are not absolutely-strict definitions in mathematics. For example, the middle (position) of a conductor may be a conductor part including a midpoint on the conductor, or may be a conductor part that includes the midpoint on the conductor and whose length is one eighth of a wavelength, where the wavelength may be a wavelength corresponding to an operating frequency band of the antenna, may be a wavelength corresponding to a center frequency of the operating frequency band, or a wavelength corresponding to resonance point. For another example, the middle (position) of the conductor may be a conductor part that is on the conductor and whose distance from the midpoint is less than a predetermined threshold (for example, 1 mm, 2 mm, or 2.5 mm).

Such limitations as symmetry (for example, axisymmetricity or centrosymmetricity) and sameness (for example, a same length and a same width) mentioned in embodiments of this application are all for a current process level, and are not absolutely-strict definitions in mathematics. A deviation of a predetermined threshold or predetermined angle may exist between two. In an embodiment, the predetermined threshold may be less than or equal to a threshold of 1 mm. For example, the predetermined threshold may be 0.5 mm, or may be 0.1 mm. In an embodiment, the predetermined angle may be an angle within a range of +10°, for example, a deviation of the predetermined angle is +5°.

Polarization direction of an antenna: At a given point in space, electric field strength E (a vector) is a function of time t. A vector endpoint periodically depicts a trajectory in space over time. Polarization is referred to as vertical polarization if the trajectory is a straight line and perpendicular to the ground. Polarization is referred to as horizontal polarization if the trajectory is horizontal to the ground. Polarization is referred to as right-hand circular polarization (right-hand circular polarization, RHCP) if the trajectory is an ellipse or a circle and rotates right-handed or clockwise with the time when viewed in a propagation direction. Polarization is referred to as left-hand circular polarization (light-hand circular polarization, LHCP) if the trajectory is an ellipse or a circle and rotates left-handed or anticlockwise with the time when viewed in a propagation direction.

Antenna pattern: The antenna pattern is also referred to as a radiation pattern. The antenna pattern refers to a pattern in which relative field strength (a normalized modulus value) of an antenna radiation field changes with a direction at a specific distance from an antenna. The antenna pattern is usually represented by two plane patterns that are perpendicular to each other in a maximum radiation direction of the antenna.

The antenna pattern usually includes a plurality of radiation beams. A radiation beam with highest radiation strength is referred to as a main lobe, and another radiation beam is referred to as a minor lobe or side lobe. In minor lobes, a minor lobe in a reverse direction of the main lobe is also referred to as a back lobe.

Antenna return loss: The antenna return loss may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

Axial ratio (axial ratio, AR) of an antenna: In circular polarization, a trajectory cyclically depicted by an electric field vector endpoint in space is an ellipse, and a ratio of a major axis to a minor axis of the ellipse is referred to as an axial ratio. The axial ratio is an important performance indicator of a circularly polarized antenna, indicates purity of circular polarization, and is an important indicator for measuring a difference between signal gains of the entire antenna in different directions. A circular polarization axial ratio of the antenna closer to 1 (the trajectory cyclically depicted by the electric field vector endpoint in the space is a circle) indicates better circular polarization performance of the antenna.

The antenna return loss may be represented by an S11 parameter, and S11 is one of S parameters. S11 indicates a reflection coefficient, and the parameter can represent transmit efficiency of the antenna. The S11 parameter is usually a negative number. A smaller S11 parameter indicates a smaller antenna return loss, less energy reflected back by the antenna, namely, more energy that actually enters the antenna, and higher total efficiency of the antenna. A larger S11 parameter indicates a larger antenna return loss and lower total efficiency of the antenna.

It should be noted that, in engineering, a value of S11 is generally-6 dB as a standard. When the value of S11 of the antenna is less than −6 dB, it may be considered that the antenna can operate normally, or it may be considered that transmit efficiency of the antenna is good.

Clearance: The clearance refers to a distance between a radiator of an antenna and a metal or electronic element near the radiator. For example, when a part of a metal side frame of the electronic device is used as the radiator of the antenna, the clearance may refer to a distance between the radiator and a printed circuit board or an electronic element (for example, a camera).

Poynting vector (poynting vector) \vec{S}: The poynting vector refers to an energy flow density vector in an electromagnetic field. On a position in space, an electric field vector is \vec{E}, a magnetic field vector is H, an energy flow density of an electromagnetic field on the position is \vec{S}=\vec{E}×\vec{H}, and a direction is determined by \vec{E} and \vec{H} according to the right-hand screw rule, where the unit is W/(m2).

Ground or ground plane: The ground or ground plane may generally mean at least a part of any grounding plane, grounding plate, ground metal layer, or the like in an electronic device (like a mobile phone), or at least a part of any combination of the foregoing grounding plane, grounding plate, ground component, or the like. The “ground” may be configured to ground components in the electronic device. In an embodiment, the “ground” may be a grounding plane of a circuit board of the electronic device, or may be a grounding plate formed by a middle frame of the electronic device or a ground metal layer formed by a metal film below a display of the electronic device. In an embodiment, the circuit board may be a printed circuit board (printed circuit board, PCB), for example, an 8-layer board, a 10-layer board, a 12-layer board, a 13-layer board, or a 14-layer board having 8, 10, 12, 13, or 14 layers of conductive materials respectively, or an element that is separated and electrically insulated by a dielectric layer or an insulation layer like a glass fiber or a polymer. In an embodiment, the circuit board includes a dielectric substrate, a grounding plane, and a wiring layer. The wiring layer and the grounding plane may be electrically connected through a via hole. In an embodiment, components such as a display, a touchscreen, an input button, a transmitter, a processor, a memory, a battery, a charging circuit, and a system on chip (system on chip, SoC) structure may be mounted on or connected to the circuit board, or electrically connected to the wiring layer and/or the grounding plane in the circuit board. For example, a radio frequency source is disposed at the wiring layer.

Any of the foregoing grounding plane, or grounding plate, or ground metal layer is made of a conductive material. In an embodiment, the conductive material may be any one of the following materials: copper, aluminum, stainless steel, brass and alloys thereof, copper foil on an insulation laminate, aluminum foil on an insulation laminate, gold foil on an insulation laminate, silver-plated copper, silver-plated copper foil on an insulation laminate, silver foil on an insulation laminate and tin-plated copper, cloth impregnated with graphite powder, a graphite-coated laminate, a copper-plated laminate, a brass-plated laminate and an aluminum-plated laminate. A person skilled in the art may understand that the grounding plane/grounding plate/ground metal layer may alternatively be made of another conductive material.

The following describes technical solutions of embodiments in this application with reference to accompanying drawings.

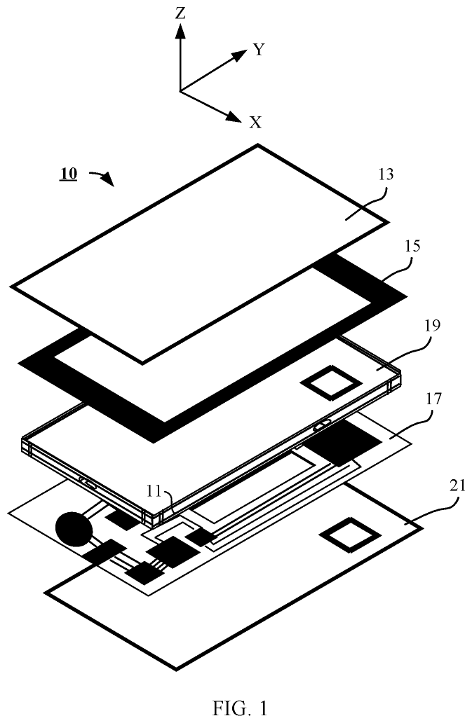

As shown in FIG. 1, an electronic device 10 may include a cover (cover) 13, a display/module (display) 15, a printed circuit board (printed circuit board, PCB) 17, a middle frame (middle frame) 19, and a rear cover (rear cover) 21. It should be understood that, in some embodiments, the cover 13 may be cover glass (cover glass), or may be replaced with a cover of another material, for example, a polyethylene terephthalate (Polyethylene terephthalate, polyethylene terephthalate PET) cover.

The cover 13 may be tightly attached to the display module 15, and may be mainly configured to protect the display module 15 for dust resistance.

In an embodiment, the display module 15 may include a liquid crystal display (liquid crystal display, LCD), a light-emitting diode (light-emitting diode, LED) display panel, an organic light-emitting semiconductor (organic light-emitting diode, OLED) display panel, or the like. This is not limited in embodiments of this application.

The middle frame 19 is mainly configured to support the entire electronic device. In FIG. 1, the PCB 17 is disposed between the middle frame 19 and the rear cover 21. It should be understood that, in an embodiment, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers (Rogers) dielectric board, or may be a hybrid dielectric board of Rogers and FR-4, or the like. Herein, FR-4 is a grade designation of a flame-resistant material, and the Rogers dielectric board is a high-frequency board. An electronic element, for example, a radio frequency integrated circuit, is carried on the PCB 17. In an embodiment, a metal layer may be disposed on the printed circuit board PCB 17. The metal layer may be configured to ground the electronic element carried on the printed circuit board PCB 17, or may be configured to ground another element, for example, a support antenna or a side frame antenna. The metal layer may be referred to as a ground plane, a grounding plate, or a grounding plane. In an embodiment, the metal layer may be formed by etching metal on a surface of any dielectric board in the PCB 17. In an embodiment, the metal layer configured for grounding may be disposed on a side that is of the printed circuit board PCB 17 that is close to the middle frame 19. In an embodiment, an edge of the printed circuit board PCB 17 may be considered as an edge of the grounding plane of the PCB 17. In an embodiment, the metal middle frame 19 may also be configured to ground the foregoing element. The electronic device 10 may further have another ground plane/grounding plate/grounding plane. As described above, details are not described herein again.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a sub-board. The battery may be disposed between the mainboard and the sub-board. The mainboard may be disposed between the middle frame 19 and an upper edge of the battery, and the sub-board may be disposed between the middle frame 19 and a lower edge of the battery.

The electronic device 10 may further include a side frame 11. The side frame 11 may be made of a conductive material like metal. The side frame 11 may be disposed between the display module 15 and the rear cover 21, and circumferentially extends around a periphery of the electronic device 10. The side frame 11 may have four sides surrounding the display module 15, to help fasten the display module 15. In an implementation, the side frame 11 made of a metal material may be directly used as a metal side frame of the electronic device 10 to form an appearance of the metal side frame, and is applicable to a metal industrial design (industrial design, ID). In another implementation, an outer surface of the side frame 11 may alternatively be made of a material other than metal, for example, a plastic side frame, to form an appearance of a non-metal side frame, and is applicable to a non-metal ID.

The middle frame 19 may include the side frame 11, and the middle frame 19 including the side frame 11 is used as an integrated part, and may support an electronic component in the entire electronic device. The cover 13 and the rear cover 21 respectively fit upper edges and lower edges of the side frame, to enclose a casing or a housing (housing) of the electronic device. In an embodiment, the cover 13, the rear cover 21, the side frame 11, and/or the middle frame 19 may be collectively referred to as a casing or a housing of the electronic device 10. It should be understood that the “casing or housing” may be used to refer to a part or all of any one of the cover 13, the rear cover 21, the side frame 11, and the middle frame 19, or refer to a part or all of any combination of the cover 13, the rear cover 21, the side frame 11, and the middle frame 19.

At least a part of the side frame 11 on the middle frame 19 may serve as a radiator of an antenna to transmit/receive a radio frequency signal. A slot may exist between the part of the side frame that serves as the radiator and another part of the middle frame 19, to ensure that the radiator of the antenna has a good radiation environment. In an embodiment, the middle frame 19 may be provided with an aperture at the part of side frame that serves as the radiator, to facilitate radiation of the antenna.

Alternatively, the side frame 11 may not be considered as a part of the middle frame 19. In an embodiment, the side frame 11 may be connected to the middle frame 19 and integrally formed. In another embodiment, the side frame 11 may include a protruding part extending inward, to be connected to the middle frame 19, for example, connected by using an elastic sheet or a screw, or connected through welding. The protruding part of the side frame 11 may be further configured to receive a feed signal, so that at least a part of the side frame 11 serves as a radiator of an antenna to receive/transmit a radio frequency signal. A slot 42 may exist between the middle frame 30 and the part of the side frame that serves as the radiator, to ensure that the radiator of the antenna has a good radiation environment, and the antenna has a good signal transmission function.

The rear cover 21 may be a rear cover made of a metal material, or may be a rear cover made of a non-conductive material, for example, may be a non-metal rear cover like a glass rear cover and a plastic rear cover, or may be a rear cover made of both a conductive material and a non-conductive material.

The antenna of the electronic device 10 may be disposed in the side frame 11. When the side frame 11 of the electronic device 10 is made of a non-conductive material, the radiator of the antenna may be located in the electronic device 10 and disposed along the side frame 11. For example, the radiator of the antenna is disposed close to the side frame 11, to reduce a volume occupied by the radiator of the antenna as much as possible, and is closer to the outside of the electronic device 10, to achieve better signal transmission effect. It should be noted that, that the radiator of the antenna is disposed close to the side frame 11 means that the radiator of the antenna may be tightly attached to the side frame 11, or may be disposed close to the side frame 11. For example, there may be a specific small slot between the radiator of the antenna and the side frame 11.

The antenna of the electronic device 10 may alternatively be disposed in the casing, for example, a support antenna or a millimeter wave antenna (not shown in FIG. 1). Clearance of the antenna disposed in the housing may be obtained by using a slit/hole in any one of the middle frame, and/or the side frame, and/or the rear cover, and/or the display, or by using a non-conductive slot/aperture formed between any several of the middle frame, and/or the side frame, and/or the rear cover, and/or the display. The clearance of the antenna may be provided, to ensure radiation performance of the antenna. It should be understood that, the clearance of the antenna may be a non-conductive area formed by any conductive component in the electronic device 10, and the antenna radiates a signal to external space through the non-conductive area. In an embodiment, a form of the antenna 40 may be an antenna form based on a flexible mainboard (flexible printed circuit, FPC), an antenna form based on laser-direct-structuring (laser-direct-structuring, LDS), or an antenna form like a microstrip disk antenna (microstrip disk antenna, MDA). In an embodiment, the antenna may alternatively use a transparent structure embedded into a display of the electronic device 10, so that the antenna is a transparent antenna element embedded into the display of the electronic device 10.

FIG. 1 shows only an example of some parts included in the electronic device 10. Actual shapes, actual sizes, and actual structures of the parts are not limited to those in FIG. 1.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that when a user holds (the user usually holds the electronic device vertically and faces the display), an orientation in which the electronic device is located has a top part, a bottom part, a left part, and a right part. It should be understood that, in embodiments of this application, it is considered that when a user holds (the user usually holds the electronic device vertically and faces the display), an orientation in which the electronic device is located has a top part, a bottom part, a left part, and a right part.

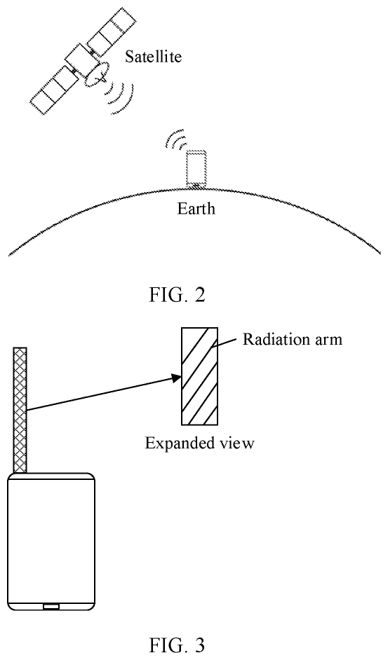

FIG. 2 is a diagram of a usage scenario of a circularly polarized antenna according to an embodiment of this application.

As shown in FIG. 2, in a satellite navigation or communication system, compared with a linearly polarized antenna, a circularly polarized antenna has some unique advantages. For example, polarization rotation (generally referred to as “Faraday rotation”) occurs when a linearly polarized wave passes through an ionosphere, but a circularly polarized wave can resist the Faraday rotation due to rotation symmetry. Therefore, the circularly polarized antenna is usually used as a transmit or receive antenna in satellite navigation or communication. In addition, in the satellite navigation or communication system, if a conventional linearly polarized antenna is used to receive a circularly polarized wave from a satellite, half of energy is lost due to polarization mismatch. In addition, the circularly polarized antenna is insensitive to directions of transmit and receive antennas.

For example, the satellite navigation or communication system may be a BeiDou satellite system, and an operating frequency band of the BeiDou satellite system may include an L frequency band (1610 MHz to 1626.5 MHz), an S frequency band (2483.5 MHz to 2500 MHz), a B1 frequency band (1559 Hz to 1591 MHz), a B2 frequency band (1166 MHz to 1217 MHz), and a B3 frequency band (1250 MHz to 1286 MHz).

FIG. 3 is a diagram of a circularly polarized antenna according to an embodiment of this application.

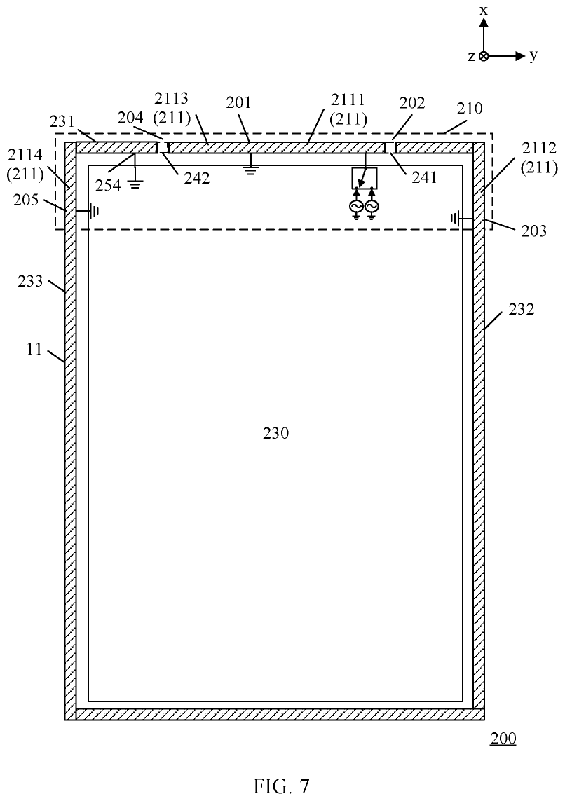

For a satellite phone, an external circularly polarized antenna is usually used. A specific antenna structure is shown in FIG. 7. The external circularly polarized antenna includes four radiation arms printed on an outer wall of a dielectric cylinder. The four radiation arms use a circularly polarized feed network, and the four radiation arms are used to perform feeding in sequence with a phase difference of [0°, 90°, 180°, 270°], thereby implementing a circularly polarized radiation pattern of a wide beam.

However, for an electronic device (for example, the mobile phone shown in FIG. 1), the external circularly polarized antenna shown in FIG. 7 is excessively large in size, and cannot be integrated into the electronic device. In addition, because a plurality of electronic elements need to be disposed in the electronic device, clearance of the antenna is generally very small (for example, the clearance of the antenna is less than or equal to 2 mm, or less than or equal to 1.5 mm), and it is difficult to reserve a large amount of space for implementing circular polarization of the antenna.

In addition, on a frequency band of a BeiDou satellite system communication technology, there is a large frequency difference between a transmit frequency band (1610 MHz to 1626.5 MHz) and a receive frequency band (2483.5 MHz to 2500 MHz) of the BeiDou satellite system communication technology, and current distribution in a case in which resonance is generated on the corresponding frequency bands is different. Therefore, a maximum radiation direction of a pattern generated on the transmit frequency band differs greatly from a maximum radiation direction of a pattern generated on the receive frequency band. This leads to a large difference, for example, greater than 45°, between the maximum radiation direction of the pattern generated on the transmit frequency band and the maximum radiation direction of the pattern generated on the receive frequency band is large. Because the transmit frequency band and the receive frequency band cannot meet a requirement for angle alignment, the transmit frequency band is aligned with a satellite (the maximum radiation direction points to the satellite), and the receive frequency band cannot be aligned with the satellite. This leads to great decrease in accuracy of transmitting a BeiDou communication short message by an antenna.

The “maximum radiation direction of the pattern” may be understood as a direction to which a maximum gain in the pattern points.

Embodiments of this application provide an electronic device, including an antenna. The antenna uses a partial side frame on two adjacent sides of a side frame as a radiator, and the antenna is separately in left-hand circular polarization and right-hand circular polarization on a first frequency band and a second frequency band by using a single feed point. In addition, because left-hand circular polarization and right-hand circular polarization are generated based on a same feed point and a same slot provided on the radiator, a difference between a maximum radiation direction of a pattern generated on the first frequency band and a maximum radiation direction of a pattern generated on the second frequency band is small, and an overlapping part between the pattern generated on the first frequency band and the pattern generated on the second frequency band increases, to meet a requirement for angle alignment of the antenna on the first frequency band and the second frequency band.

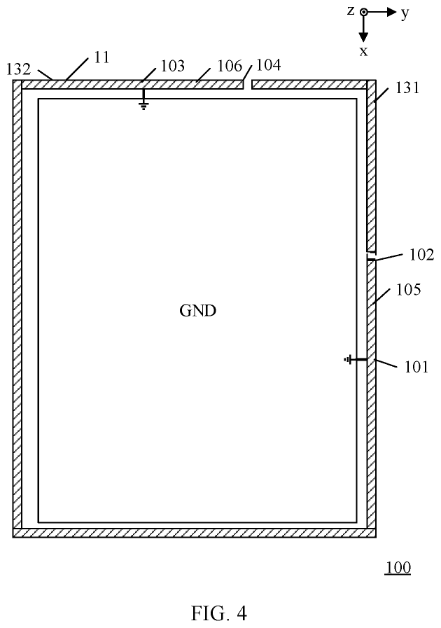

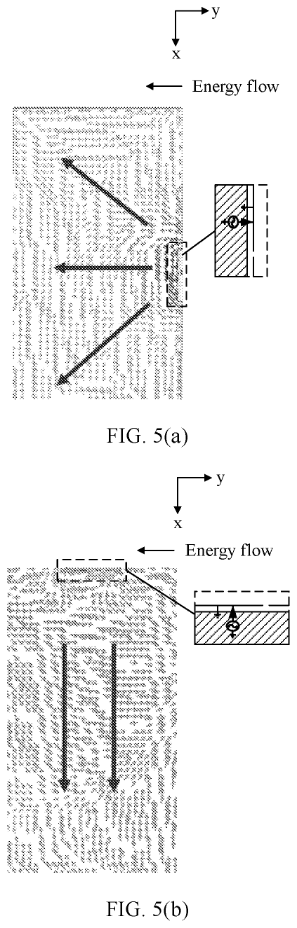

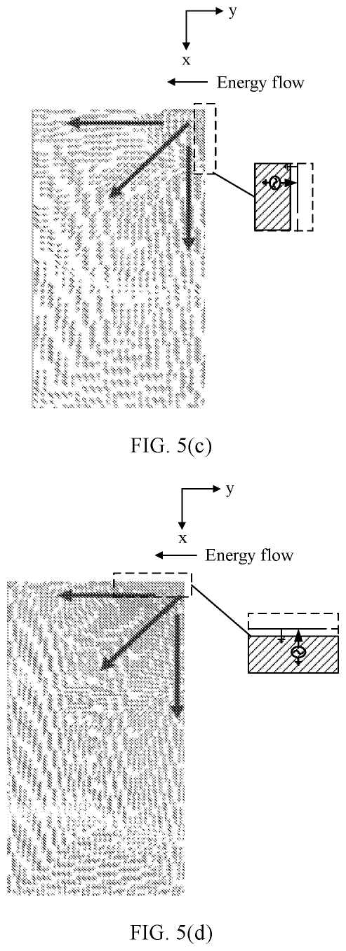

FIG. 4 and FIG. 5(a) to FIG. 5(d) describe two antenna modes in this application.

As shown in FIG. 4, the electronic device 100 may include a conductive side frame 11.

The side frame 11 includes a first side frame 105 and a second side frame 106. The side frame 11 may include a first side 131 and a second side 132 that intersect at an angle, and a length of the first side 131 is greater than a length of the second side 132. The first side frame 105 may be located on the first side 131 of the side frame 11, and the second side frame 106 may be located on the second side 132 of the side frame 11. The first side 131 may have a first position 101 and a second position 102, and the second side 132 may have a third position 103 and a fourth position 104. A side frame between the first position 101 and the second position 102 is the first side frame 105, and a side frame between the third position 103 and the fourth position 104 is the second side frame 106.

The first side frame 105 and the second side frame 106 may be used as radiators of the antenna 110 in the electronic device 100.

It should be understood that, in this embodiment of this application, the side frame (for example, the first side frame 105 and the second side frame 106) may be a conductive side frame, or may be a non-conductive side frame having a conductive patch (disposed on an inner surface or disposed in an embedded manner), and conductive parts of the first side frame 105 and the second side frame 106 are used as radiators of the antenna 110.

When an electrical signal is fed on the first side frame, energy flow (a Poynting vector) generated by the first side frame has a component (a current direction is perpendicular to an energy flow direction, and is an x direction) in a y-axis direction, and the energy flow distribution is understood as a longitudinal mode generated by the antenna, as shown in FIG. 5(a). When an electrical signal is fed on the second side frame, energy flow generated by the second side frame has a component (a current direction is perpendicular to an energy flow direction, and is a y direction) in an x-axis direction, and the energy flow distribution is understood as a transverse mode generated by the antenna, as shown in FIG. 5(b). When the first side frame or the second side frame is disposed on an area (for example, an overlapping area between the first side and the second side) near an intersection of the first side and the second side, energy flow (a Poynting vector) generated by the first side frame or the second side frame has components in both an x-axis direction and a y-axis direction, and the antenna may generate both a transverse mode and a longitudinal mode. For example, when the first side frame is disposed on an intersection area (a part of the first side frame on the first side is greater than a part of the first side frame on the second side), energy flow (a Poynting vector) generated by the first side frame is shown in FIG. 5(c). When the first side frame is disposed on an area (a part of the first side frame on the second side is greater than a part of the first side frame on the first side) near an intersection, energy flow (a Poynting vector) generated by the first side frame is shown in FIG. 5(d).

It should be understood that, for brevity of description, this application is described by using only an example in which the intersection between the first side and the second side is at a right angle. The area near the intersection of the first side and the second side may be understood as an area within a first threshold (for example, 5 mm or 10 mm) away from the intersection. In addition, during actual application, the intersection of the first side and the second side may be arc-shaped. Therefore, the area near the intersection of the first side and the second side may be understood as an area within a first threshold (for example, 5 mm or 10 mm) away from a midpoint of the arc-shaped intersection. This is not limited in embodiments of this application.

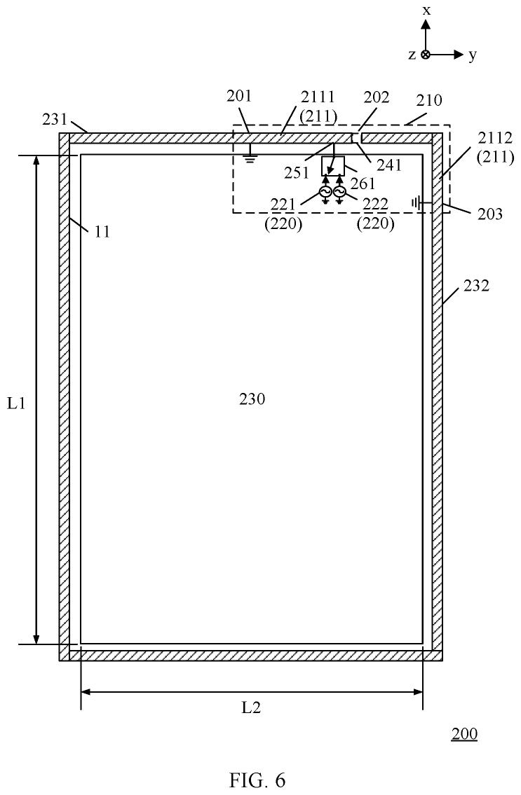

FIG. 6 is a diagram of a structure of an electronic device 200 according to an embodiment of this application.

As shown in FIG. 6, the electronic device 200 may include a conductive side frame 11, a first antenna 210, and a feed element 220.

The side frame 11 may include a first side 231 and a second side 232 that intersect at an angle. The first side 231 includes a first position 201 and a second position 202. The second side 232 includes a third position 203. The second position 202 is located between the first position 201 and the third position 203, and the second position 202 is provided with a first slot 241. A side frame 11 between the first position 201 and the second position 202 is a first side frame 2111. A side frame 11 between the second position 202 and the third position 203 is a second side frame 2112.

The first antenna 210 includes a radiator 211. The radiator 211 includes the first side frame 2111 and the second side frame 2112. The first side frame 2111 is coupled to the ground plane 230 at the first position 201 for grounding. The second side frame 2112 is coupled to the ground plane 230 at the third position 203 for grounding. The first side frame 2111 includes a first feed point 251. An operating frequency band of the first antenna 210 includes a first frequency band and a second frequency band, and a frequency of the first frequency band is lower than a frequency of the second frequency band.

It should be understood that, for brevity of description, in this embodiment of this application, only an example in which the side frame or the radiator is electrically connected to the ground plane 230 for grounding is used for description. In actual production or design, the side frame or the radiator may be alternatively grounded through indirect coupling.

The feed element 220 may include a first radio frequency channel 221 and a second radio frequency channel 222. The first radio frequency channel 221 is coupled to the first side frame 2111 at the first feed point 251, and the second radio frequency channel 222 is coupled to the first side frame 2111 at the first feed point 251. An operating frequency band of the first radio frequency channel 221 includes the first frequency band, and an operating frequency band of the second radio frequency channel 222 includes the second frequency band. That the operating frequency band of the first radio frequency channel 221 includes the first frequency band may be understood as that the first radio frequency channel 221 is used to transmit a radio frequency signal (an electrical signal) whose frequency is on the first frequency band, and the operating frequency band of the second radio frequency channel 222 may also be correspondingly understood.

It should be understood that, for brevity of description, in this embodiment of this application, only an example in which the feed element 220 is electrically connected to the side frame or the radiator for a feed connection is used for description. In actual production or design, the feed connection of the side frame or the radiator may alternatively be implemented through indirect coupling.

According to the technical solution in this embodiment of this application, when a radio frequency signal is fed at the first feed point 251, the radiator 211 may simultaneously excite the longitudinal mode and the transverse mode in the foregoing embodiment on the first frequency band and the second frequency band, so that a polarization manner of the first antenna is circular polarization. In an embodiment, resonance of the first antenna 210 on the first frequency band is mainly excited by the first side frame 2111, and resonance on the second frequency band is mainly excited by the second side frame 2112. An open end (an ungrounded end) of the first side frame 2111 is located on a first side (for example, a left side) of the first slot 241, and an open end of the second side frame 2112 is located on a second side (for example, a right side) of the first slot 241. Therefore, a circular polarization rotation direction of the first frequency band excited by the first side frame 2111 is reverse to a circular polarization rotation direction of the second frequency band excited by the second side frame 2112, so that the first antenna can be used in a satellite communication system (in the satellite communication system, a circular polarization rotation direction of a transmit frequency band is reverse to a circular polarization rotation direction of a receive frequency band).

In addition, because both the resonance generated on the first frequency band and the resonance generated on the second frequency band are generated when a radio frequency signal is fed at a same feed point, and the resonance generated on the first frequency band and the resonance generated on the second frequency band share the first slot 241 provided at the second position 202, a difference between a maximum radiation direction of a pattern generated on the first frequency band and a maximum radiation direction of a pattern generated on the second frequency band is small, so that an overlapping part between the pattern generated on the first frequency band and the pattern generated on the second frequency band increases, to meet a requirement for angle alignment of the first antenna 210 on the first frequency band and the second frequency band. The overlapping part between the pattern generated on the first frequency band and the pattern generated on the second frequency band can enable the electronic device to have good satellite communication performance.

In an embodiment, a length of the first side frame 2111 is greater than a length of the second side frame 2112.

It should be understood that, because the resonance of the first antenna 210 on the first frequency band is mainly excited by the first side frame 2111, the resonance on the second frequency band is mainly excited by the second side frame 2112, and a frequency of the first frequency band is lower than a frequency of the second frequency band, correspondingly, the length of the first side frame 2111 is greater than the length of the second side frame 2112. In an embodiment, an electronic element may be disposed between the first side frame 2111 and the ground plane 230, or an electronic element may be disposed between the second side frame 2112 and the ground plane 230, to shorten a physical size of the side frame when an electrical length of the side frame remains unchanged. Therefore, the length of the first side frame 2111 may alternatively be less than the length of the second side frame 2112. However, when the physical size of the side frame is shortened by loading an electronic element, a radiation aperture of the first antenna is reduced, and radiation performance of the first antenna is reduced.

In an embodiment, an angle difference between the maximum radiation direction of the pattern generated on the first frequency band and the maximum radiation direction of the pattern generated on the second frequency band is less than or equal to 30°. When the angle difference between the maximum radiation direction of the pattern generated on the first frequency band and the maximum radiation direction of the pattern generated on the second frequency band is less than or equal to 30°, it may be considered that the first antenna 210 is angle-aligned on the first frequency band and the second frequency band.

In an embodiment, a circular polarization axial ratio of the first antenna 210 on the first frequency band is less than or equal to 10 dB. In an embodiment, a circular polarization axial ratio of the first antenna 210 on the second frequency band is less than or equal to 10 dB. It should be understood that, when the circular polarization axial ratio of the first antenna 210 is less than or equal to 10 dB, it may be considered that the first antenna 210 has a good circular polarization characteristic.

In an embodiment, a polarization manner of the first antenna 210 on the first frequency band is left-hand circular polarization. In an embodiment, a polarization manner of the first antenna 210 on the second frequency band is right-hand circular polarization.

In an embodiment, the first frequency band may include a transmit frequency band (1610 MHz to 1626.5 MHz) of a BeiDou satellite system communication technology. In an embodiment, the second frequency band may include a receive frequency band (2483.5 MHz to 2500 MHz) of the BeiDou satellite system communication technology.

In an embodiment, the first radio frequency channel 221 and the second radio frequency channel 222 may be two different radio frequency channels (for example, may be two different pins (pins) of a radio frequency integrated chip) in the radio frequency integrated chip (RF IC).

In an embodiment, a ratio of a length L1 to a width L2 of the ground plane 230 may be greater than or equal to 1.5. In an embodiment, a ratio of a length L1 to a width L2 of the ground plane 230 may be less than or equal to 3. It should be understood that, when the length L1 and the width L2 of the ground plane 230 are at a proper ratio, a good horizontal mode and a good longitudinal mode may be generated through excitation.

In an embodiment, the length L1 and the width L2 of the ground plane 230 may be determined by a contour formed by superposing metal parts that may be used as the ground plane in the electronic device 200. For example, when the electronic device is the mobile phone shown in FIG. 1, the length L1 and the width L2 of the ground plane 230 may be determined by a length and a width of a rectangular contour formed by a middle frame, a PCB, and another edge that may be used as a whole of the metal part of the ground plane. In an embodiment, based on compactness inside the electronic device, a ground plane (for example, a middle frame, a PCB, a battery, and the like each may be considered as a part of the ground plane) is usually disposed in internal space 0 mm to 2 mm away from an inner surface of the side frame. A medium is filled between the side frame and the ground plane, and a length and a width of a rectangle enclosed by an inner surface contour of the filled medium may be considered as a length and a width of the ground plane.

In an embodiment, a distance L3 between the first position 201 and the third position 203 and a length L4 of the first side 2111 satisfy the following: 7×L4/16≤L3≤9×L4/16. In an embodiment, the length of the first side 2111 may be understood as a length of the first side 2111 extending in a y direction, or a width of the electronic device. When the electronic device is a foldable device, the length may be understood as a length and a width of the electronic device in a folded state.

It should be understood that the distance between the first position 201 and the third position 203 may be understood as a distance from the first position 201 to the third position 203 along the first side 231 and the second side 232. In this embodiment of this application, for a distance between two positions on the side frame, refer to the foregoing descriptions. Details are not described again.

In an embodiment, a distance between the first feed point 251 and the second position 202 is less than one third of a distance between the first position 201 and the second position 202, so that the first antenna 210 can excite resonance on the first frequency band and resonance on the second frequency band.

It should be understood that the distance to the second position 202 may be understood as a distance to a center of the slot 241 provided at the second position 202.

In an embodiment, a length of the first side 231 is less than a length of the second side 232. When a user holds the electronic device (the user usually holds the electronic device vertically and faces a display), the first antenna 210 may be disposed on the top of the electronic device, to avoid that radiation performance of the first antenna 210 deteriorates because excessive radiation is absorbed by the first antenna 210 when the user holds the electronic device.

In an embodiment, the electronic device 200 may further include a first switch 261, where a common port of the first switch 261 is coupled to the first side frame 2111 at the first feed point 251, a first port of the first switch 261 is electrically connected to the first radio frequency channel 221, and a second port of the first switch 261 is electrically connected to the second radio frequency channel 222.

It should be understood that the first switch 261 may be configured to switch an electrical connection state between the first feed point 251 and each of first radio frequency channel 221 and the second radio frequency channel 222, so that a radio frequency signal is fed through the first radio frequency channel 221 and the second radio frequency channel 222 at the first feed point 251 in different timeslots, to implement time division duplex (time division dual, TDD) of a feed circuit.

In an embodiment, the first switch 261 may be a single-pole four-throw (single-pole four-throw, SPFT) switch. It should be understood that, in this embodiment of this application, the switch may be selected based on actual production or design, or may be a single-pole multi-throw (single-pole x-throw, SPXT) switch. This is not limited in embodiments of this application, provided that a quantity of connection ports of the switch is greater than a quantity of electronic elements or radio frequency channels that need to be connected.

In an embodiment, the side frame 11 may further include a third side 233 that intersects the first side 231 at an angle, as shown in FIG. 7. The first side 231 may further include a fourth position 204, and the first position 201 may be located between the second position 202 and the fourth position 204. The third side 233 may include a fifth position 205. In an embodiment, the fifth position 205 may alternatively be located on the first side 231. This is not limited in embodiments of this application, and may be adjusted based on actual production or design. For brevity of description, only an example in which the fifth position 205 is disposed on the third side 233 is used for description. The fourth position 204 is provided with a second slot 242. The side frame 11 between the first position 201 and the fourth position 204 is a third side frame 2113. The side frame 11 between the fourth position 204 and the fifth position 205 is a fourth side frame 2114.

The radiator 211 includes the third side frame 2113 and the fourth side frame 2114. The fourth side frame 2114 is coupled to the ground plane 230 at the fifth position 205 for grounding. The fourth side frame 2114 includes a connection point 254, and the fourth side frame 2114 is coupled to the ground plane 230 at the connection point 254 for grounding.

It should be understood that the connection point 254 may be configured to adjust current distribution on the ground plane 230 when the first antenna 210 operates on the first frequency band, so that the maximum radiation direction of the pattern generated on the first frequency band is close to the maximum radiation direction of the pattern generated on the second frequency band, and the difference between the maximum radiation direction of the pattern generated on the first frequency band and the maximum radiation direction of the pattern generated by the second frequency band is reduced. This increases an overlapping degree between the pattern generated on the first frequency band and the pattern generated on the second frequency band, and improves accuracy of transmitting a BeiDou communication short message by the first antenna 210.

In addition, the first position 201 is a position between the second position 202 and the third position 203, radiation performance (for example, a position of a resonance point and a maximum radiation direction) of the first antenna 210 on the first frequency band may be adjusted.

In an embodiment, a distance between the connection point 254 and the fourth position 204 is less than a distance between the connection point 254 and the fifth position 205, so that the maximum radiation direction of the pattern generated on the first frequency band is closer to the maximum radiation direction of the pattern generated on the second frequency band.

In an embodiment, the first slot 241 and the second slot 242 may be symmetrical along a virtual axis of the first side 231, and the virtual axis may be understood as a symmetry axis of the first side 231. It should be understood that, as symmetry of the structure of the first antenna 210 increases, radiation performance of the first antenna 210 increases accordingly.

In an embodiment, the first feed element 220 may further include a third radio frequency channel 223, and the third radio frequency channel 223 may be electrically connected to a third port of the first switch 261.

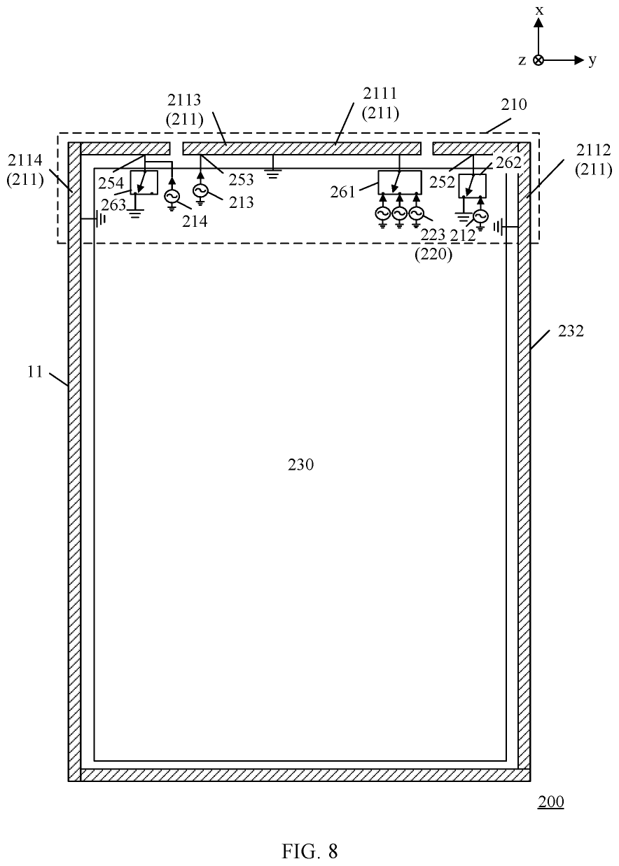

In an embodiment, the electronic device 200 may further include a second feed element 212, a third feed element 213, and a fourth feed element 214, as shown in FIG. 8. The second side frame 2112 includes a second feed point 252, and the third side frame 2113 includes a third feed point 253. The second feed element 212 is coupled to the second side frame 2112 at the second feed point 252. The third feed element 213 is coupled to the third side frame 2113 at the third feed point 253. The fourth feed element 214 is coupled to the fourth side frame 2114 at the connection point 254 (when a radiator is reused, the connection point 254 may be used as a fourth feed point).

It should be understood that the first side frame 2111 and the third radio frequency channel 223 in the first feed element 220 may form a second antenna (when the first antenna 210 does not operate, a common port of the first switch 261 is conducted with the third port, and a radio frequency signal is fed through the third radio frequency channel 223). In an embodiment, an operating frequency band of the second antenna may include at least some low frequency bands of a cellular network, for example, B5 (824 MHz to 849 MHz), B8 (890 MHz to 915 MHz), and B28 (704 MHz to 747 MHz) in LTE.

The second side frame 2112 and the second feed element 212 may form a third antenna. In an embodiment, an operating frequency band of the third antenna may include at least some medium-high frequency bands of a cellular network, for example, B1 (1920 MHz to 1980 MHz), B3 (1710 MHz to 1785 MHz), and B7 (2500 MHz to 2570 MHz) in LTE.

The third side frame 2113 and the third feed element 213 may form a fourth antenna. In an embodiment, an operating frequency band of the fourth antenna may include at least a part of a 5G frequency band and a sub-6G frequency band (for example, a frequency band N77, N78, or N79) of Wi-Fi.

The fourth side frame 2114 and the fourth feed element 214 may form a fifth antenna. In an embodiment, an operating frequency band of the fifth antenna may include at least an L5 frequency band of GPS and a 2.4G frequency band of Wi-Fi.

Because a spatial layout in the electronic device is compact, the first antenna 210 may reuse a radiator with an antenna on another frequency band, so that antenna layouts on more communication frequency bands are implemented in same space. The operating frequency band of the second antenna, the third antenna, the fourth antenna, or the fifth antenna is merely used as an example. During actual application, the operating frequency band may be adjusted based on a production or design requirement. This is not limited in embodiments of this application.

In an embodiment, the electronic device 200 further includes a second switch 262, a common port of the second switch 262 is coupled to the second side frame 2112 at the second feed point 252, a first port of the second switch 262 is grounded, and a second port of the second switch 262 is electrically connected to the second feed element 212.

In an embodiment, the electronic device 200 further includes a third switch 263, a common port of the third switch 263 is coupled to the fourth side frame 2114 at the connection point 254, and a first port of the third switch 263 is grounded.

It should be understood that, because the first antenna 210 reuses a radiator with the second antenna, the third antenna, the fourth antenna, and the fifth antenna, when the first antenna 210 operates, none of the second antenna, the third antenna, the fourth antenna, and the fifth antenna operates.

Correspondingly, the common port of the first switch 261 is conducted with the first port (the first radio frequency channel) and the second port (the second radio frequency channel) in different timeslots, so that the radio frequency signals of the first frequency band and the second frequency band are fed at the first feed point.

On a satellite communication frequency band, power of a radio frequency signal fed at the first feed point is large. When the second switch 262 is not disposed, a part of the radio frequency signal is reversely fed from the second feed point 252 into the second feed element 212, causing damage to an electronic element between the second feed point 252 and the second feed element 212. Therefore, when the first antenna 210 operates, the common port of the second switch 262 is conducted with the first port, so that the second side frame 2112 is grounded at the second feed point 252. This prevents the radio frequency signal fed at the first feed point from being reversely fed into the second feed element 212, and the electronic element between the second feed point 252 and the second feed element 212 is not damaged.

The common port of the third switch 263 is conducted with the first port, so that the fourth side frame 2114 is grounded at the connection point 254. The fourth side frame 2114 may be grounded at the connection point 254, so that the maximum radiation direction of the pattern generated on the first frequency band is close to the maximum radiation direction of the pattern generated on the second frequency band.

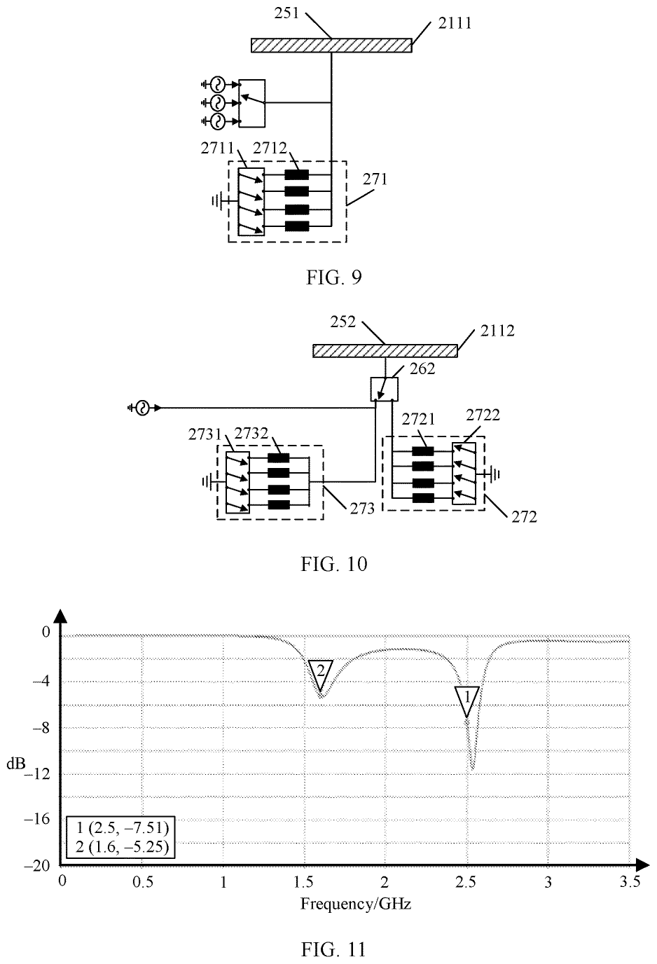

In an embodiment, the electronic device may further include a first matching network 271, as shown in FIG. 9. The first matching network 271 may be configured to implement impedance matching for the first antenna on the first frequency band.

It should be understood that the matching network may match a radio frequency signal in a feed element with a feature (for example, impedance matching) of a radiator, so that a transmission loss and distortion of the radio frequency signal are reduced to a minimum, and radiation performance of the antenna is improved. In addition, different impedances may also be used to adjust a frequency of a resonance point of resonance generated by the first antenna on the first frequency band.

In an embodiment, the first matching network 271 may include a fourth switch 2711 and a plurality of electronic elements 2712, the electronic elements 2712 may be electrically connected between the first feed point 251 and the fourth switch 2711, and a common port of the fourth switch 2711 is grounded.

In an embodiment, the fourth switch 2711 may be a multi-pole multi-throw (x-pole x-throw, XPXT) switch.

It should be understood that, the fourth switch 2711 may be configured to: when the first antenna operates on the first frequency band, adjust an impedance value of the first feed point 251, to improve radiation performance of the first antenna on the first frequency band. In addition, different impedances may also be used to adjust a frequency of a resonance point of resonance generated by the first antenna on the second frequency band.

In an embodiment, the electronic device may further include a second matching network 272, as shown in FIG. 10. The second matching network 272 may be configured to implement impedance matching for the first antenna on the second frequency band. In an embodiment, the electronic device may further include a third matching network 273, as shown in FIG. 10. The third matching network 273 may be configured to: when the first antenna does not operate, implement impedance matching for the third antenna on the second frequency band. In addition, different impedances may also be used to adjust a frequency of a resonance point of resonance generated by the second antenna, so that a resonance frequency band of the second antenna may include different communication frequency bands.

In an embodiment, the second matching network 272 may include a fifth switch 2721 and a plurality of electronic elements 2722. The electronic elements 2722 may be electrically connected between the first port of the second switch 262 and the fifth switch 2721, and a common port of the fifth switch 2721 is grounded.

It should be understood that, when the first antenna operates, the common port of the second switch 262 is conducted with the first port, and the fifth switch 2721 may be configured to: when the first antenna operates on the second frequency band, adjust an impedance value of the second feed point 252, to improve radiation performance of the first antenna on the second frequency band.

In an embodiment, the third matching network 273 may include a sixth switch 2731 and a plurality of electronic elements 2732. The electronic elements 2732 may be electrically connected between the second port of the second switch 262 and the sixth switch 2731, and a common port of the sixth switch 2731 is grounded.

It should be understood that, when the first antenna does not operate and when the third antenna operates, the common port of the second switch 262 is conducted with the second port, and the sixth switch 2731 may be configured to adjust, when the third antenna operates, an impedance value of the second feed point 252, to improve radiation performance of the third antenna.

In an embodiment, the fifth switch 2721 or the sixth switch 2731 may be a multi-pole multi-throw (x-pole x-throw, XPXT) switch.

FIG. 11 is a diagram of a simulation result of an S parameter of the first antenna 210 shown in FIG. 8.

As shown in FIG. 11, the first antenna may generate resonance near 1.6 GHz and resonance near 2.5 GHz.

When S11<−4 dB, an operating frequency band of the first antenna may include 1610 MHz to 1626.5 MHz and 2483.5 MHz to 2500 MHz.

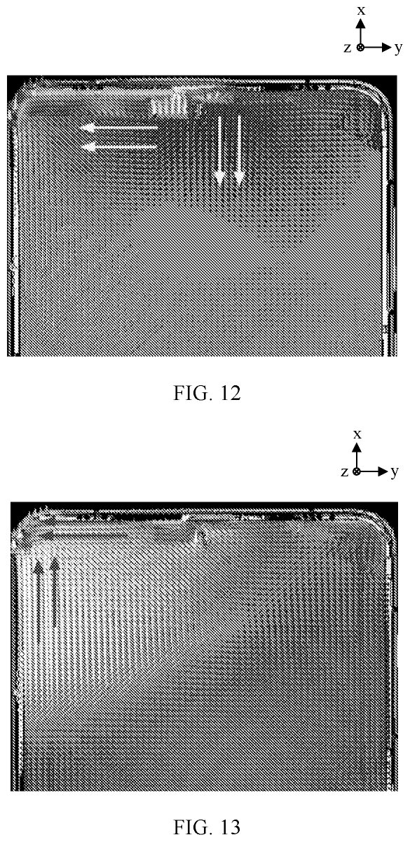

FIG. 12 and FIG. 13 are diagrams of current distribution of the first antenna 210 shown in FIG. 8 when the first antenna 210 operates. FIG. 12 is a diagram of current distribution of the first antenna 210 shown in FIG. 8 on a first frequency band (1.62 GHz). FIG. 13 is a diagram of current distribution of the first antenna 210 shown in FIG. 8 on a second frequency band (2.5 GHZ).

As shown in FIG. 12, when the first antenna operates on the first frequency band (1.62 GHZ), a first current toward the left (in a y-axis negative direction) and a second current toward the bottom (in an x-axis negative direction) may be generated on a ground plane in a horizontal mode and a longitudinal mode. The first current and the second current may enable the first antenna to be in left-hand circular polarization on the first frequency band (1.62 GHZ).

As shown in FIG. 13, when the first antenna operates on the second frequency band (2.5 GHZ), a third current toward the left (in a y-axis positive direction) and a fourth current toward the bottom (in an x-axis positive direction) may be generated on a ground plane in a horizontal mode and a longitudinal mode. The third current and the fourth current may enable the first antenna to be in right-hand circular polarization on the second frequency band (2.5 GHZ).

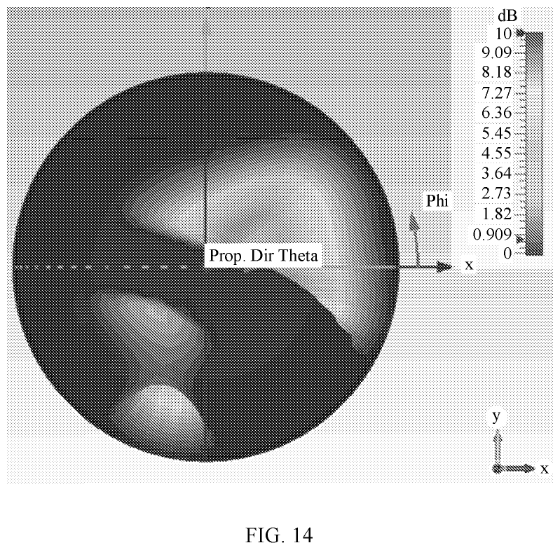

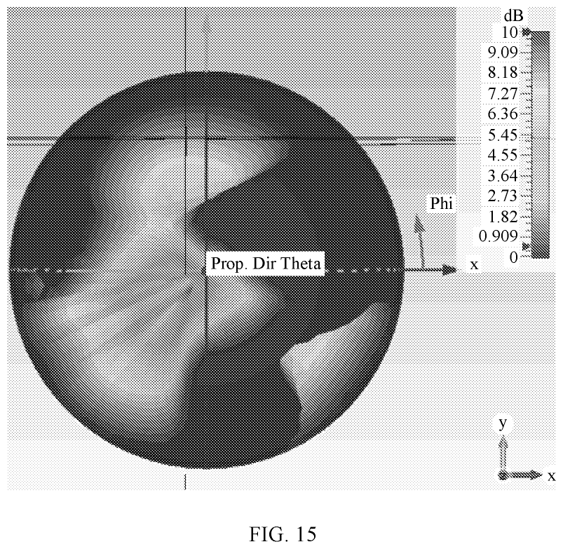

FIG. 14 and FIG. 15 are axial ratio patterns of the first antenna 210 shown in FIG. 8. FIG. 14 is an axial ratio pattern of the first antenna 210 shown in FIG. 8 on a first frequency band (1.62 GHz). FIG. 15 is an axial ratio pattern of the first antenna 210 shown in FIG. 8 on a second frequency band (2.5 GHZ).

As shown in FIG. 14, an axial ratio pit appears in a z direction (a display direction of an electronic device) in the axial ratio pattern generated by the first antenna on the first frequency band (1.62 GHZ). In this area, an axial ratio requirement (for example, axial ratio<10 dB) of circular polarization may be met, and the antenna presents a circular polarization characteristic.

As shown in FIG. 15, an axial ratio pit appears in a z direction (a display direction of an electronic device) in the axial ratio pattern generated by the first antenna on the second frequency band (2.5 GHZ). In this area, an axial ratio requirement (for example, axial ratio<10 dB) of circular polarization may be met, and the antenna presents a circular polarization characteristic.

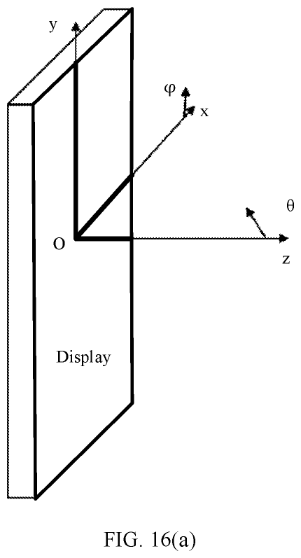

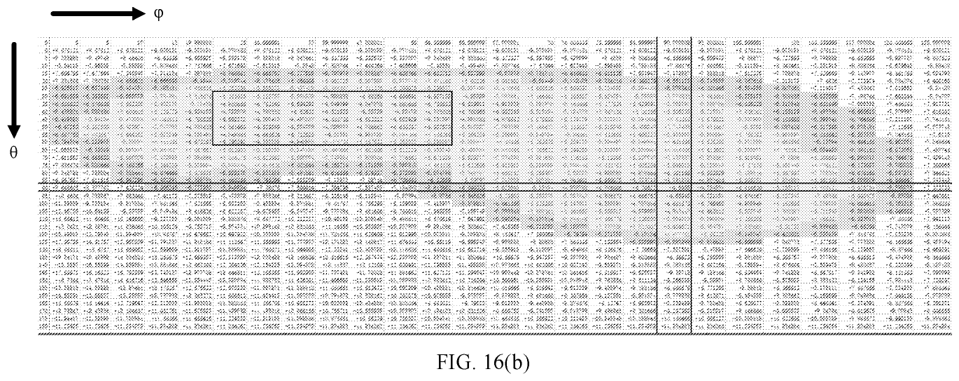

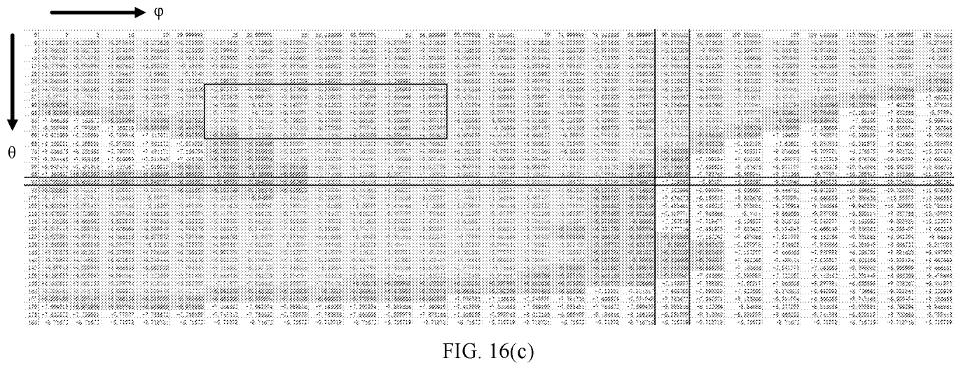

FIG. 16(a) to FIG. 16(c) show gain simulation results of the first antenna 210 shown in FIG. 8 on a first frequency band (1.62 GHz) and a second frequency band (2.5 GHZ).

It should be understood that, as shown in FIG. 16(a), q is an angle between a xoy plane and an x-axis, and θ is an angle between the xoy plane and a z-axis.

FIG. 16(b) and FIG. 16(c) respectively show gain simulation results of the first antenna on the first frequency band (1.62 GHZ) and the second frequency band (2.5 GHZ).

As shown in FIG. 16(b) and FIG. 16(c), a pattern generated by the first antenna on the first frequency band (1.62 GHZ) in left-hand circular polarization and a pattern generated by the first antenna on the second frequency band (2.5 GHZ) in right-hand circular polarization overlap in an area of 25°≤φ≤55° and 30° 30≤60°, and a radiation beam generated within this range may enable an electronic device to have good performance in satellite communication.

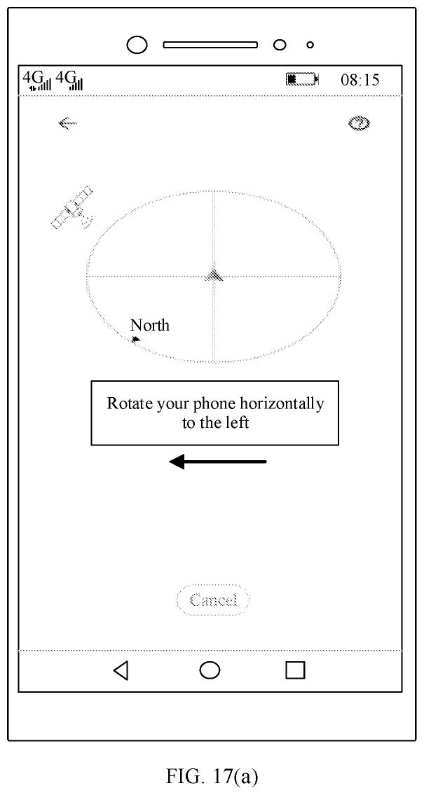

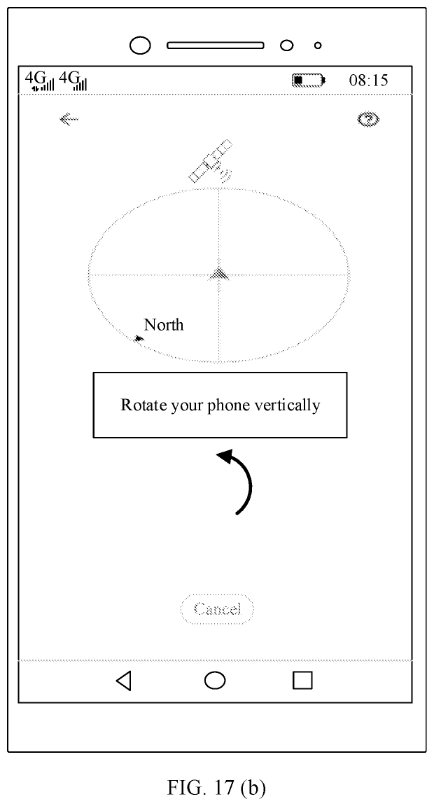

FIG. 17 (a) and FIG. 17 (b) are a diagram of a group of graphical user interfaces (graphical user interfaces, GUIs) according to an embodiment of this application.

It should be understood that, because satellite communication performance in an overlapping area between a pattern generated by a first antenna on a first frequency band and a pattern generated by the first antenna on a second frequency band is good, when a user needs to perform satellite communication, the user needs to be instructed to align with a satellite. FIG. 17 (a) and FIG. 17 (b) are a diagram of a GUI for instructing a user to perform alignment. This is merely used as an example. This is not limited in embodiments of this application.

As shown in FIG. 17 (a), when the user enables satellite communication, an electronic device displays a position of the satellite on an interface, and instructs the user to align with the satellite in a horizontal direction (for example, a direction parallel to the horizontal plane).

As shown in FIG. 17 (b), when the user completes alignment with the satellite in the horizontal direction, the user may be instructed to align with the satellite in the vertical direction (for example, a direction perpendicular to the horizontal plane).

When the user completes the steps shown in FIG. 17 (a) and FIG. 17 (b), the overlapping area between the pattern generated by the first antenna on the first frequency band and the pattern generated by the first antenna on the second frequency band may be aligned with the satellite for satellite communication.

FIG. 18 is a diagram of another electronic device 200 according to an embodiment of this application.

As shown in FIG. 18, the electronic device includes a hinge 310, a first housing 301, and a second housing 302.

The hinge 301 is located between the first housing 301 and the second housing 302, and the hinge 310 is rotatably connected to the first housing 301 and the second housing 302 separately. The first housing 301 includes a first conductive side frame 321, and the second housing 302 includes a second conductive side frame 322.

It should be understood that a difference between the electronic device 200 shown in FIG. 18 and the electronic device 200 in the foregoing embodiment lies only in that the electronic device 200 shown in FIG. 18 is a foldable electronic device, and the first antenna 210 in the foregoing embodiment may be disposed on the first conductive side frame 321, and correspondingly, the second antenna, the third antenna, the fourth antenna, and the fifth antenna may also be disposed correspondingly.

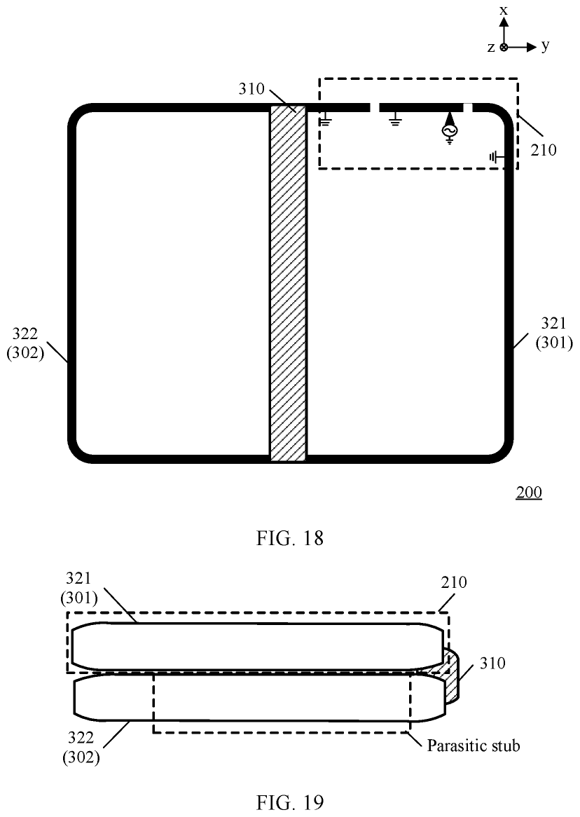

In an embodiment, when the electronic device 200 is in a folded state, as shown in FIG. 19, the first conductive side frame 321 is close to the second conductive side frame 322, and a partial side frame on the second conductive side frame 322 may be used as a parasitic stub of the first antenna 210 (or the second antenna, the third antenna, the fourth antenna, and the fifth antenna).

It should be understood that, in the folded state, the parasitic stub disposed on the second conductive side frame 322 may be used to improve efficiency of the antenna disposed on the first conductive side frame 321. In addition, the parasitic stub may be used to guide a maximum radiation direction of a pattern generated on a first frequency band or a maximum radiation direction of a pattern generated on a second frequency band, so that an overlapping part between the pattern generated on the first frequency band and the pattern generated on the second frequency band can improve satellite communication performance of the electronic device.

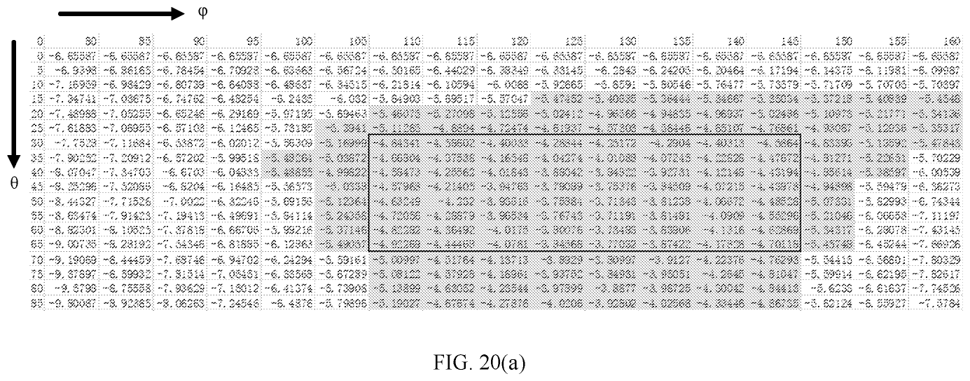

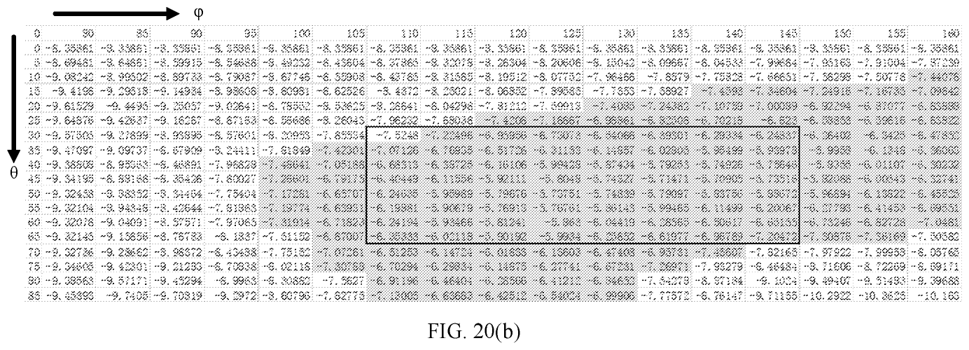

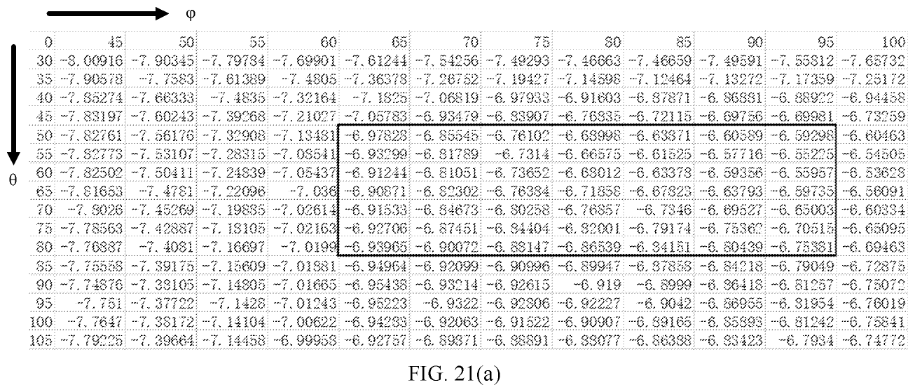

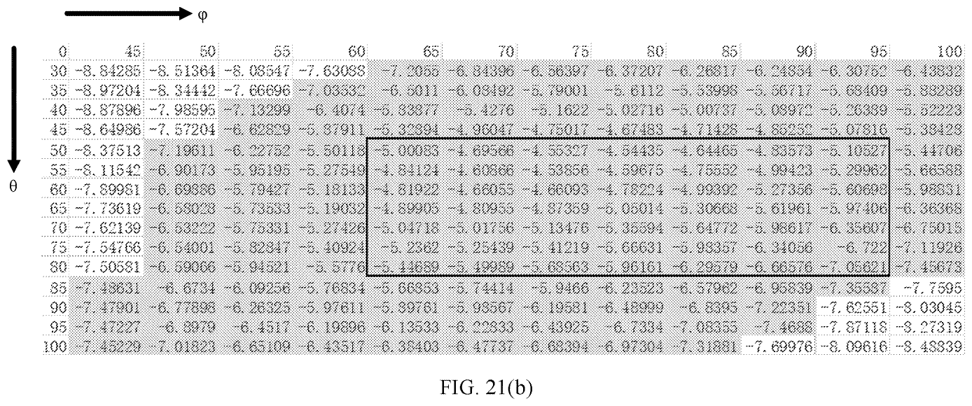

FIG. 20(a) to FIG. 21(b) show gain simulation results of the first antenna shown in FIG. 18 on a first frequency band (1.62 GHZ) and a second frequency band (2.5 GHz). FIG. 20(a) and FIG. 20 (b) show gain simulation results of the first antenna on the first frequency band (1.62 GHz) and the second frequency band (2.5 GHZ) when the electronic device shown in FIG. 18 is in an unfolded state. FIG. 21(a) and FIG. 21(b) show gain simulation results of the first antenna on the first frequency band (1.62 GHZ) and the second frequency band (2.5 GHZ) when the electronic device shown in FIG. 18 is in a folded state.

FIG. 20(a) and FIG. 20(b) respectively show gain simulation results of the first antenna on the first frequency band (1.62 GHZ) and the second frequency band (2.5 GHZ) when the electronic device is in the unfolded state.

As shown in FIG. 20(a) and FIG. 20(b), when the electronic device is in the unfolded state, a pattern generated by the first antenna on the first frequency band (1.62 GHZ) in left-hand circular polarization and a pattern generated by the first antenna on the second frequency band (2.5 GHZ) in right-hand circular polarization overlap in an area of 110°≤φ≤145° and 30°≤θ≤65°, and a radiation beam generated within this range may enable the electronic device to have good performance in satellite communication.

FIG. 21(a) and FIG. 21(b) respectively show gain simulation results of the first antenna on the first frequency band (1.62 GHZ) and the second frequency band (2.5 GHZ) when the electronic device is in the folded state.

As shown in FIG. 21(a) and FIG. 21(b), when the electronic device is in the folded state, a pattern generated by the first antenna on the first frequency band (1.62 GHZ) in left-hand circular polarization and a pattern generated by the first antenna on the second frequency band (2.5 GHz) in right-hand circular polarization overlap in an area of 65°≤φ≤95° and 50°<<80°, and a radiation beam generated within this range may enable the electronic device to have good performance in satellite communication.

A person skilled in the art may use different methods to implement the described functions for each specific application, but such implementation should not be considered beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-18. (canceled)

19. An electronic device, comprising:
a first conductive side frame, wherein the first conductive side frame comprises a first side and a second side that intersect at an angle, the first side comprises a first position and a second position, the second side comprises a third position, the second position is located between the first position and the third position, the second position is provided with a first slot, a side frame between the first position and the second position is a first side frame, and a side frame between the second position and the third position is a second side frame;
an antenna, wherein the antenna comprises a radiator, the radiator comprises the first side frame and the second side frame, the first side frame is grounded at the first position, the second side frame is grounded at the third position, the first side frame comprises a first feed point, an operating frequency band of the antenna comprises a first frequency band and a second frequency band, and a frequency of the first frequency band is lower than a frequency of the second frequency band; and
a first feed element, wherein the first feed element comprises a first radio frequency channel and a second radio frequency channel, the first radio frequency channel is coupled to the first side frame at the first feed point, the second radio frequency channel is coupled to the first side frame at the first feed point, an operating frequency band of the first radio frequency channel comprises the first frequency band, and an operating frequency band of the second radio frequency channel comprises the second frequency band.

20. The electronic device according to claim 19, wherein
the electronic device further comprises a first switch, a common port of the first switch is coupled to the first side frame at the first feed point, a first port of the first switch is electrically coupled to the first radio frequency channel, and a second port of the first switch is electrically coupled to the second radio frequency channel.

21. The electronic device according to claim 20, wherein
the first side comprises a fourth position, the first position is located between the second position and the fourth position, the fourth position is provided with a second slot, and a side frame between the first position and the fourth position is a third side frame,
wherein the side frame further comprises a third side that intersects the first side at an angle, the third side or the first side comprises a fifth position, and a side frame between the fourth position and the fifth position is a fourth side frame, and
wherein the radiator comprises the third side frame and the fourth side frame.

22. The electronic device according to claim 21, wherein the first slot and the second slot are symmetrical along a virtual axis of the first side.

23. The electronic device according to claim 21, wherein the fourth side frame comprises a connection point, and the fourth side frame is grounded at the fifth position and the connection point.

24. The electronic device according to claim 23, wherein a distance between the connection point and the fourth position is less than a distance between the connection point and the fifth position.

25. The electronic device according to claim 23, wherein
the first feed element further comprises a third radio frequency channel, and the first radio frequency channel is electrically coupled to a third port of the first switch,
wherein the electronic device further comprises a second feed element, a third feed element, and a fourth feed element,
wherein the second side frame comprises a second feed point, and the second feed element is coupled to the second side frame at the second feed point,
wherein the third side frame comprises a third feed point, and the third feed element is coupled to the third side frame at the third feed point, and
wherein the fourth feed element is coupled to the fourth side frame at the connection point.

26. The electronic device according to claim 25, wherein
the electronic device further comprises a second switch, a common port of the second switch is coupled to the second side frame at the second feed point, a first port of the second switch is grounded, and a second port of the second switch is electrically coupled to the second feed element.

27. The electronic device according to claim 25, wherein
the electronic device further comprises a third switch, a common port of the third switch is coupled to the fourth side frame at the connection point, and a first port of the third switch is grounded.

28. The electronic device according to claim 26, wherein
the electronic device further comprises a first matching network, the first matching network comprises a fourth switch and a plurality of first electronic elements, the first electronic element is electrically coupled between the first feed point and the fourth switch, and a common port of the fourth switch is grounded.

29. The electronic device according to claim 26, wherein
the electronic device further comprises a second matching network, the second matching network comprises a fifth switch and a plurality of second electronic elements, the second electronic element is electrically coupled between the first port of the second switch and the fifth switch, and a common port of the fifth switch is grounded.

30. The electronic device according to claim 26, wherein
the electronic device further comprises a third matching network, the third matching network comprises a sixth switch and a plurality of third electronic elements, the third electronic element is electrically coupled between the second port of the second switch and the sixth switch, and a common port of the sixth switch is grounded.

31. The electronic device according to claim 19, wherein
the electronic device comprises a hinge, a first housing, and a second housing, wherein
the hinge is located between the first housing and the second housing, the hinge is rotatably coupled to the first housing and the second housing separately, the first housing comprises the first conductive side frame, and the second housing comprises a second conductive side frame.

32. The electronic device according to claim 19, wherein
a distance between the first feed point and the second position is less than one third of a distance between the first position and the second position.

33. The electronic device according to claim 19, wherein
a circular polarization axial ratio of the antenna on the first frequency band is less than or equal to 10 dB; and/or
a circular polarization axial ratio of the antenna on the second frequency band is less than or equal to 10 dB.

34. The electronic device according to claim 19, wherein
a distance L3 between the first position and the third position and a length L4 of the first side satisfy the following: 7×L4/16≤L3≤9×L4/16.

35. The electronic device according to claim 19, wherein the first frequency band comprises 1610 MHz to 1626.5 MHz, and/or the second frequency band comprises 2483.5 MHz to 2500 MHz.

36. The electronic device according to claim 19, wherein
a polarization manner of the antenna on the first frequency band is left-hand circular polarization; and/or
a polarization manner of the antenna on the second frequency band is right-hand circular polarization.
